(19) United States
(12) Patent Application Publication
(10) Pub. No.: US 2002/0080163 A1
(43) Pub. Date: Jun. 27, 2002

(54) Information retrieval system

(76) Inventor: Dale D. Morey, Salt Lake City, UT (US)

Correspondence Address: Lloyd W. Sadler or Daniel P. McCarthy, Parsons Behle & Latimer, Suite 1800, 201 South Main Street, Lake City, UT, 84111-2218, US

(21) Appl. No.: 09/885,795

(22) Filed: Jun. 19, 2001

Related U.S. Application Data
(63) Continuation-in-part of application No. 09/028,078, filed on Feb. 23, 1998, now abandoned.

(51) Int. Cl. G09G 5/00; H04N 7/173

(52) U.S. Cl. 345/727; 725/109; 725/112

(57) ABSTRACT

A system and method are described for the access and retrieval of information, which integrates television, video and/or similar sources with the information resources available on the Internet. This invention permits a user to select an item displayed on a television screen and, without significant interruption, order the item or request additional information on the item or provide feedback to the television source signal provider, for example, the television network or advertiser.

### CROSS REFERENCE TO RELATED APPLICATIONS

This application is Continuation-In-Part application of U.S. patent application Ser. No. 09/028,078, which was filed on Feb. 23, 1998, and priority is claimed thereto.

### BACKGROUND OF THE INVENTION

1. Field of the Invention

This invention relates to systems and methods for the retrieval of information over electronic computer networks. More specifically this invention relates to systems and methods for accessing information related to objects, products and/or images presented on video displays, whether originating from broadcast television signals (such as satellite, microwave, cable or RF transmissions), video cassette, video disks, or the like, using an audio/video (A/V) source, an A/V display, an A/V transceiver, a remote control device, an internet connection, and an information data base, to define the viewing, selection and interaction with a user and the transceiver and the video display.

2. Description of Related Art

The success of television, motion pictures and commercials has each enabled vastly improved communication of ideas, products, services and information to a nearly world wide audience. However, by and large, the communications has been one way only. Recently the development of the Internet permits two way person-to-person communications. However, thus far, Internet communications has not been integrated with video communications. Such integration offers substantial improvement in effective communication between the advertisers of ideas, products, services and information and potential customers of such advertisers. Such integration of the internet and video communication would facilitate the communication of additional information to interested potential customers by offering an advertiser the ability to provide requested details, take orders and/or gather information regarding the effectiveness of the advertising.

Advertising has become an increasingly important aspect of the marketing of products, services and/or ideas. Advertisers are showing increased willingness to pay more and more for preferred commercials and time slots. With the advent of new communication technology, i.e., the internet and other electronic data bases, potential customers are able to access, store and retrieve large amounts of information in a relatively short time period. To be effective communication tools, storage and retrieval systems must be easy to operate and must require the minimum of special training. Consumers are becoming more sophisticated and tired of commercials. Meanwhile, advertisers feel increased pressure to display their goods and services. Both consumers and advertisers are beginning to use the Internet as a method for gathering and communicating information.

The information age has come in to its own with the arrival of the Internet. It is now possible for many consumers to access the vast resources of information available on the Internet. Similarly, many advertisers are beginning to see the Internet as a channel for communicating commercial advertising to sophisticated consumers. Nevertheless, while both consumers and advertisers fully understand the video technology, the potential of the Internet for most consumers and advertisers has barely been scratched. The combination of television (and its derivatives, such as recorded programs and subscribed programs), Internet and audio-visual user interfaces presents both consumers and advertisers with a unique new opportunity to provide interactive advertising programs. Internet provides the ability to store and retrieve more information quicker and easier than ever before.

A variety of data base retrieval systems and tools have been developed and, to varying degrees, are well known in the art. Such systems and tools include: an interactive multimedia system with distributed processing and storage of video picture information and associated data and sound in nodes disposed throughout a cable television distribution system; an electronic device and method for accessing remote electronic facilities and displaying associated information on a conventional television set; a signal distribution system having a converter with input terminals for receiving signals of varying configurations and an output terminal for transmitting converted signals; a system for interactively viewing videos, wherein a selected video is transmitted as a plurality of frames of digitized video data for playback on a viewing device; an apparatus and method for shopping at home using a video catalog in which a plurality of product images are established and coordinated with a corresponding product identification in an order form; an electronic device and method for accessing remote electronic facilities and displaying associated information on a conventional television set; an interactive audio-visual transceiver coupled to a television and/or telephone cable, a television, a video recorder and other audio-visual devices, wherein a remote control device is provided to communicate with the audio-visual transceiver to permit the user to interactively manage the selection of program and service sources, selection program and service offerings from any selected source, viewing of selected program offerings and interaction with selected service offerings; an interactive television system in which the television program and a computer program are integrated to provide a viewer-friendly environment in which the viewer can participate on a real time basis with other viewers; and an apparatus for authoring multimedia assets into a final interactive multimedia application including a storage device which stores one or more multimedia assets and one or more program objects and having a display for displaying a plurality of timelines.

For general background material, the reader is directed to U.S. Pat. Nos.: 5,220,420, 5,319,455, 5,361,091, 5,404,393, 5,442,390, 5,451,998, 5,561,708, 5,574,964, 5,583,560, 5,621,456, 5,640,192, and 5,659,793, each of which is hereby incorporated by reference in its entirety for the material disclosed therein.

### SUMMARY OF INVENTION

It is desirable to provide a system, method and apparatus for providing an interactive interface between displayed video and the Internet. Specifically, it is desirable to provide a system, method and apparatus, which provide Internet links for selected goods or services, which are displayed on a video monitor or television.

Accordingly, it is the general object of this invention to provide a system for linking Internet information to displayed video objects for retrieval by a user.

It is a further object of this invention to provide an interactive audio visual transceiver connectable to a user's television, cable, satellite receiver, video cassette recorder (VCR), digital video disk (DVD) or other audio-visual (A/V) source, and which is also connected to an internet service provider (ISP) through a cable, phone line or other connection.

Another object of this invention is to provide a method for communicating a selected item (product or service) displayed on the video screen to an Internet located information database.

A further object of this invention is to provide a method for communicating selected Internet located information to a user.

It is a still further object of this invention to provide a remote control device for communicating the user's selections to the interactive audio-visual transceiver.

Another object of this invention is to provide a menu driven method for user communication of selected displayed items to an Internet sited database.

A further object of this invention is to provide a method for permitting the user to move from link to link in the Internet sited database.

It is a further object of this invention to provide a method for providing advertisers with information about users who select goods or services and who access the advertisers' Internet sites.

These and other objects of this invention will be readily apparent to those of ordinary skill in the art upon the review of the following description, drawings and claims of this disclosure.

These and other objects of this invention are achieved by a system, apparatus and method which links internet stored information to displayed goods and/or services which uses a digital channel of internet addresses, having data corresponding to a number representing the link and its position as to where it is positioned on the display screen, and a digital interface channel connected to an Internet Service Provider (ISP). In the current preferred embodiment of the invention, an interactive audio-visual transceiver is connected to a user's television, cable, satellite receiver, VCR, DVD, and/or other A/V inputs, and is also connected to an ISP through a cable, telephone line or other Internet channel connection. The preferred A/V transceiver is built in one unit having two modules. A main module, including a central processing unit (CPU) coupled to a digital system bus to system memory and an Infrared or similar remote control unit. The main module is also coupled over an audio-visual bus to an audio-visual decoder, an audio-visual processor, an audio-visual encoder, a television or other video output display device, an audio-visual connection module connected to one or more audio-visual sources, including one or more internet connections and one to a digital input channel. The audio-visual transceiver hardware includes an operating system program, which supports the functions provided in the present invention.

In operation, the cable, satellite, television signal, DVD or VCR transmits a continuous data stream. In addition to the regular audio-visual signal and/or embedded into the regular audio-visual signal source, a data stream is provided which includes internet addresses corresponding to a graphical number representing the link and its screen positioning. This data stream is received by the transceiver. A remote control device is preferably provided for communicating with the transceiver, and includes several interactive functions that are user selectable. These buttons include a “Links” button, a “Close” button, an “Enter” button, a numeric keypad, channel and volume selection buttons, as well as dual operational buttons for left, right, up and down arrow buttons. A keyboard communicating over an infrared link to the transceiver may also be provided for an alternative user interaction with the Internet. By pressing on the “Links” button, the links that are available will be displayed as digital graphical overlay numbers on the screen indicating the items to which they are associated. By depressing the number corresponding to the item in which the user is interested and depressing “Enter”, the link is displayed in the upper left corner of the display, thereby indicating that it has been selected. Next, the Internet address is automatically saved in memory and the links on the screen are removed from the display until the “Links” button is again depressed. After the “Links” button is depressed the available links continue to be displayed until a link is selected or until the “Close” button is pushed. During, or after the movie or program is over, the user can switch to the internet by depressing the “Web” button which in turn connects the user to the user's ISP through cable or telephone connection where the user can access the links that were previously selected. A menu created by the audio-visual transceiver would allow a user to delete a link or continue on to the next link. The transceiver also allows the user to move from one link to another by use of the arrow buttons on the remote control unit. Information entered by the user upon registration of the user's transceiver purchase is stored in memory and can be sent to advertisers, providing information on the users who visited the advertiser's site.

### BRIEF DESCRIPTION OF DRAWINGS

FIG. 1 is a functional block diagram showing the preferred components of the audio-visual transceiver.

FIG. 2 is a functional block diagram showing the audio-visual system of this invention.

FIG. 3 is a diagram illustrating the digital data that will be received by the transceiver.

FIG. 4 is an illustration of the preferred remote control unit for use in this invention.

FIG. 5 illustrates the process of a user watching a movie and after pressing the “Links” button on the remote control unit; the digital overlaid links are displayed.

FIG. 6 illustrates the selection of “Link” for verification.

FIG. 7a illustrates the return to the movie or program with no “links” showing.

FIG. 7b illustrates the switch from television to Internet, where the user can connect to bookmarked pages.

FIG. 8a illustrates the selection of desired bookmark.

FIG. 8b illustrates a view of an Internet web page of the selected “link.”

FIG. 9a illustrates a regular commercial on television.

FIG. 9b illustrates Internet web pages of previously bookmarked commercial.

FIGS. 10a and 10b are front and side views of the preferred controller of this invention.

### DETAILED DESCRIPTION

Notation & Nomenclature: The detailed descriptions, which follow, are presented largely in terms of interface display images, algorithms, and symbolic representations of the operations of data bits within a computer memory. These algorithmic descriptions and representations are the means used by those skilled in the art to effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, displayed and otherwise manipulated. It proves convenient at times, principally for the reasons of common usage, to refer to these signals as bits, values, elements, symbols, characters, images, terms, numbers, or the like. It should be borne in mind, however, that all of these and similar terms are to be associated with the appropriate physical quantities and are merely convenient labels to these quantities. In the present case, the operations are machine operations performed in conjunction with a human operator. Useful machines for performing the options of the present invention include general-purpose digital computers, digitally controlled displays or other similar devices. In all cases, there should be borne in mind the distinction between the method operations of operating a computer and/or display system, and the method of computation itself. The present invention relates to method steps for operating a computer and an interactive display system, and processing electrical or other physical signals to generate other desired physical signals. The present invention also relates to apparatus for performing these operations. This apparatus may be specially constructed for the required purposes or it may comprise a general-purpose computer selectively activated or reconfigured by a computer program stored in the computer. The method steps presented herein are not inherently related to any particular computer or other apparatus. In particular, various general-purpose machines may be used with programs in accordance with the teachings herein, or it may prove more convenient to construct more specialized apparatus to perform the required method steps. The required structure for a variety of these machines will appear from the description given below. Machines, which may perform the functions of the present invention, include those of manufacturers of computer and computer controlled multi-systems.

The following detailed description describes a general system structure for receiving and generating the audio user interface of the present invention. Within the following sections, the functional aspects such as the web option, and the selection will be described and illustrated. Also included, is the description and functionality of the overall structure and operation of the present invention's user interface. In the following description, a variety of specific details are set forth such as functional blocks representing data processing devices, and metaphors such as screen, menu and other configurations to assist the user in navigating through the user interface, etc., to provide a thorough understanding of the present invention. However, it will be apparent to one skilled in the art that the present invention may be practiced without these specific details. In other instances, well-known circuits and structures are not described in detail so as not to obscure the present invention unnecessarily. For the purpose of this application, the word “audio and its abbreviation, “A/V”, will be used interchangeably and will have the same meaning.

General System Configuration

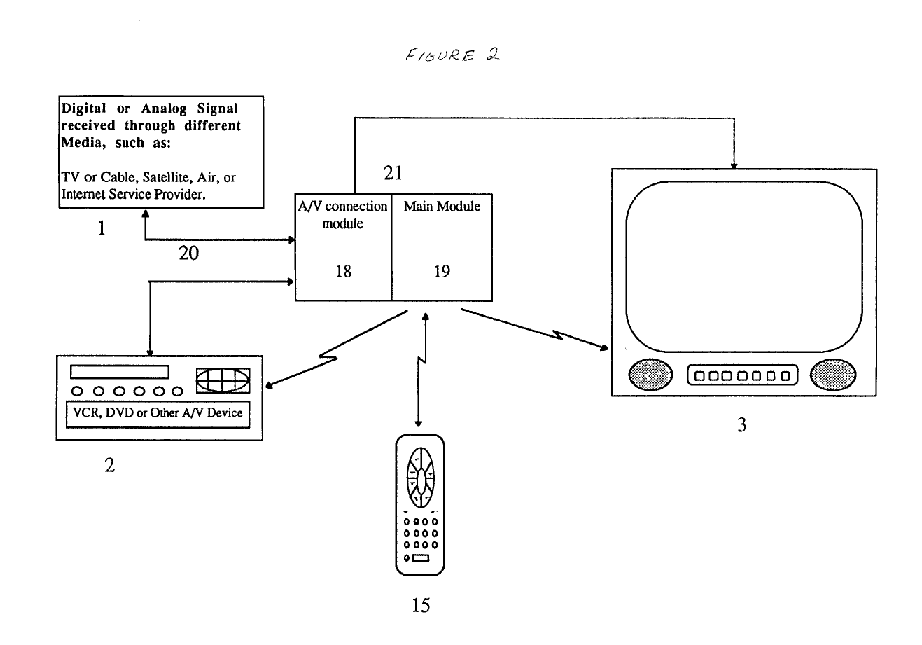

The multimedia interactive television system of the present invention is illustrated in schematic form in FIG. 2. As shown in FIG. 2, a cable, telephone service provider, satellite company, Standard TV Station, or Internet Service Provider 1 provides a channel of television/video service and a channel of data service, over a T/T cable 20 to the equipment of one or more users, which is coupled to the cable or telephone system. Although in this specification reference is made to a cable television or telephone system, it will be appreciated by one skilled in the art that the present invention may be used in conjunction with a variety of other electronic transmission systems including but not limited to, satellite service systems, microwave systems, fiber optic, and radio frequency (RF) systems. As illustrated in FIG. 2, the T/T cable 20 is coupled to an A/V transceiver 21, which comprises two separately identifiable modules, and A/V connection module 18 and a main module 19. The transceiver 21 is intended to be located in proximity to and coupled to a VCR, DVD or other A/V device 2, a television (“TV”) 3, and some type of service provider 1 as explained previously. Moreover, it is contemplated that transceiver 21 may be directly incorporated into the VCR, DVD or other A/V device 2, or the TV 3. As will be described in greater detail below, a remote control device 15 communicates, preferably through a wireless transmission signal (for example, an infrared (IR) signal), or other mechanisms known in the art, with the transceiver 21. Additionally, as illustrated in FIG. 2, the transceiver 21 is further capable of communicating with the television 3, and the VCR, DVD or other A/V devices through infrared or other communication means known in the art.

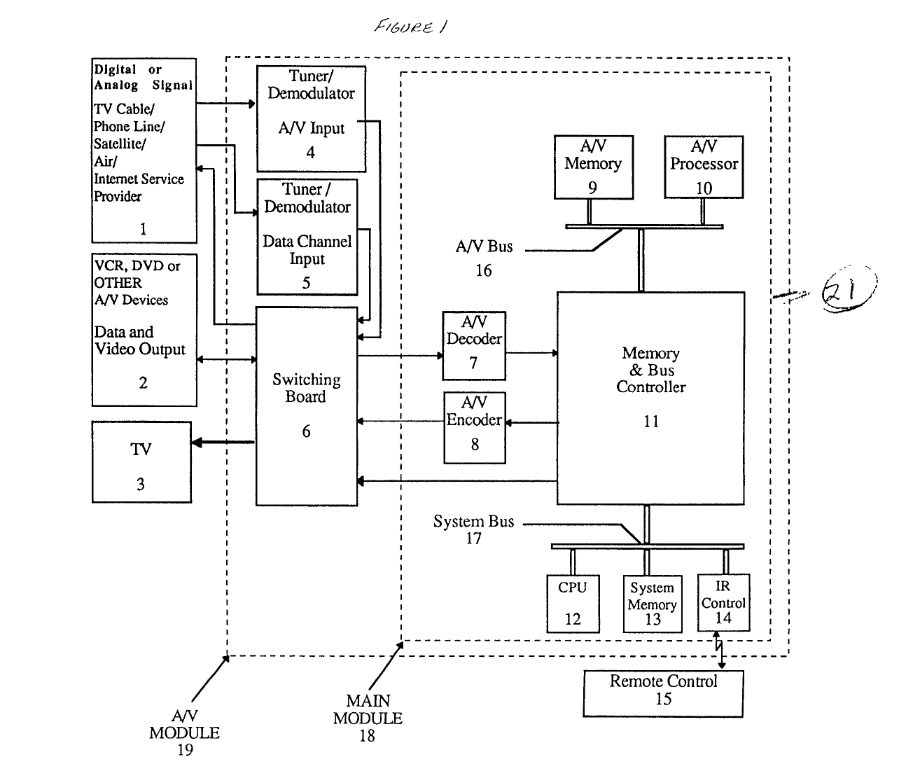

Referring now to FIGS. 1 and 2, the transceiver 21 comprises two primary modules: a main module 18, and an A/V connect module 19. The main module 18 includes a central processing unit (CPU) 12 coupled over a system bus 17 to a system memory 13 and an infrared (IR) control unit 14, which sends and receives wireless control signals to and from the remote control device 15. The CPU 12 is further coupled through the system bus 17 to a memory and bus controller 11, which is itself coupled through an A/V decoder 7 and an A/V encoder 8 to the A/V connect module 19. The CPU 12 is also coupled through the system bus 17, the memory and bus controller 11 and an A/V bus 16 to an A/V processor 10 and an optional A/V memory 9. The A/V connect module 19 switches and receives analog/digital audio signals and digital data from a plurality of audio sources including the T/T cable 20, VCR, DVD or other A/V devices 2, and couples those signals and data to the main module 18 through the video decoder 7. The A/V connect module further switches audio signals and data received from the main module 18 through the video encoder 8, and sends them back out to the T/T cable 20, the VCR, DVD or other A/V devices 2, and/or the TV 3. The A/V connect module 19 includes a switching board 6 and one or more programmable tuners/demodulators 4 and 5, wherein one tuner/demodulator reads and displays a current program from one of the channels received over the T/T cable 20, and additional tuners/demodulators (or alternatively, the same tuner/demodulator) are used to read and display data from a separate and corresponding data channel (analog signal,) or the compressed data channel stripped out of a single digital channel (digital broadcast). In addition, the A/V connect module 19 may include descrambling circuitry (not shown) to descramble premium programs received over the T/T cable 20. It is further contemplated that the A/V connect module 19 provides a graphic digital overlay function that superimposes an A/V signal from the video encoder 8 against another A/V signal from the T/T cable 20, the VCR, DVD or other A/V device 2, allowing both signals to be simultaneously displayed on the TV 3. Finally, the A/V connect module 19 can be used to transmit data through the cable (T/T) service provider as is now commonly used through the Internet. The A/V decoder 7 is used to decode data encoded in the vertical blanking interval into digital data, or to decode digital data from a digital signal generated by the service providers 1 and couple them to the CPU 12 through the memory and bus controller 11 and the system bus 17. Furthermore, the A/V decoder 7 is used to convert analog audio signals from the A/V connect module 19 into digital A/V data and couple them to the A/V processor 10 through the memory and bus controller 11 and the A/V bus 16. It is also contemplated that the A/V decoder 7 may be used to decompress certain analog or digital signals (such as MPEG motion video and the like) and couple them to the A/V processor 10 through the memory and bus controller 11 and the A/V bus 16. The memory and bus controller 11 is used to route data and control signals between the system bus 17, the A/V bus 16, the A/V decoder 7, and the A/V encoder 8. The A/V bus 16 is a high speed digital bus used to free up the system bus 17 during the transmission of large amount of audio data between the A/V processor 10, the optional A/V memory 9 and, through the memory and bus controller 11, the A/V decoder 7, and the A/V encoder 8. The A/V processor 10 coupled to the A/V bus 16 is used to manipulate, process, render, and otherwise rearrange digital data into coherent audio displays. An optional A/V memory module 9 also coupled to the A/V bus 16 can be used to store A/V data before or after processing by the A/V processor 10, using components such as video random access memory (VRAM) to hold, for example, a frame buffer equivalent to one 170×480×8 bit color image in memory. The A/V encoder 8, coupled to the A/V bus 16 through the memory and bus controller 11, is used to convert digital A/V data from the A/V processor 10 or the optional A/V memory 9 into analog audio signals which are routed to the TV 3, the VCR, DVD or other A/V devices 2 through the A/V connect module 19. It is also contemplated that the A/V encoder 8 may be used to encode other data such as internet protocol and data requests sent by the CPU 12 through the memory and bus controller 11 and the system bus 17 and transmit them to the service provider 1 through the A/V connect module 19 to the Internet Service Provider of choice. The CPU 12 is also coupled over the system bus 17 to a system memory 13 including both volatile and nonvolatile memory components. The nonvolatile part of system memory 13 includes read only memory (such as ROM), which is used to store an operating system and playback software, fonts, sounds and the like used in the present invention. The nonvolatile part of system memory 13 also includes rewritable memory (such as SRAM), which is used for persistent storage of bookmarks or links, viewed link history, consumer information, main service provider phone, user name and password and other user preferences. Additionally, the volatile part of system memory 13 includes sufficient random access memory (such as RAM or DRAM) for the temporary storage of data received over the T/T cable 20 or from the other devices 2 connected to the transceiver 21.

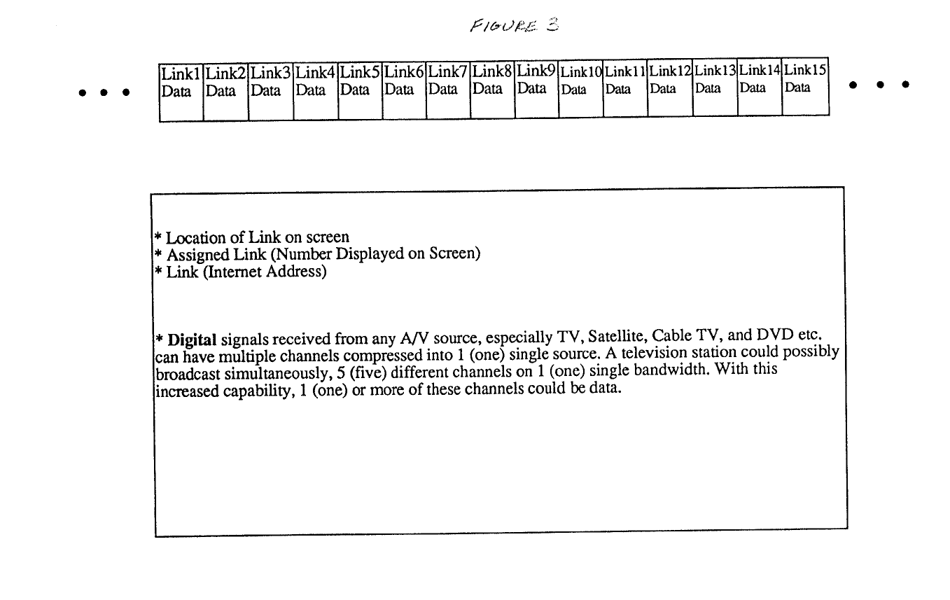

Referring now to FIG. 3, there is shown one section of data from the T/T cable 20. Included in this data is the location of the bookmark on the TV 3 or monitor, assigned graphical digital number, and corresponding Internet address. Data will be a continuous stream, thereby allowing the link number to actually move with the corresponding A/V image. The Internet connection in combination with this invention is used to provide the communication channel for a variety of transactions, including but not limited to: ordering products, using home banking services and accessing pay movies. Also, user information can be sent to advertisers, to give the advertisers immediate customer information and statistics, which can be used to provide improved product and/or service customer targeting.

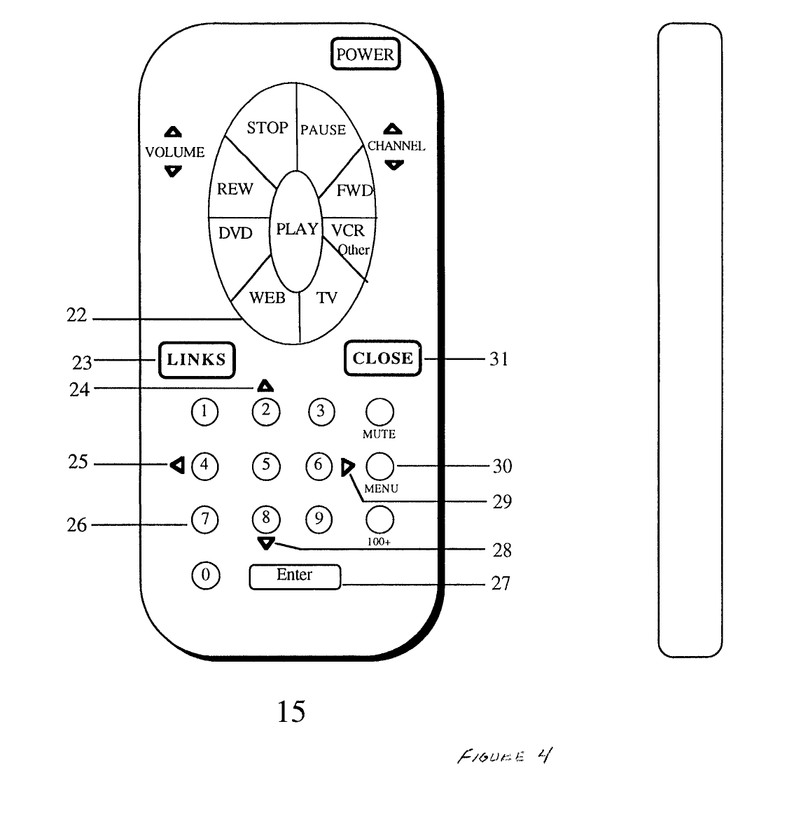

Referring now to FIG. 4 one possible and the current preferred embodiment of the remote control device 15 is shown in further detail. The functionality of the buttons and their usage will be described below. The remote control device 15 of the present invention resembles a standard electronic remote control unit, consisting mainly of a numeric keypad 25, miscellaneous switching buttons to switch between usage of peripheral devices such as TV, DVD, VCR or other A/V devices, a Web button 22, a Links button 23, a Close button 29 and multi-buttons 24, 25, 28, 29. A graphical digital overlay on the screen will facilitate selection of choices from one to another.

The Web button 22 will allow a user to switch to the Internet. Depressing the web button 22 will switch the multi-buttons 24, 25, 28, 29 to function as arrow buttons, facilitating navigation on the Internet and user interface as depicted in Diagram 8a.

When depressed, the Links button 23 will switch the transceiver 21 so that it will display the regular A/V signal and will also activate and display the digital data channel information as a digital graphical overlay as depicted in Diagram 5b. The digital overlay of numbers will continue to display on the TV 3 until the Close button 31 is depressed, or until the user has selected a link. Link selection will typically be in the form of entering the corresponding number from the numeric keypad and depressing the Enter key 27. When a selection has been completed, the selected link will be displayed for a short interval to allow for user verification of selected link, and then links will be disappear until Links button 23 is depressed again.

Multi-buttons are the numeric “2” button 24, the “4” button 25, the “6” button 29, and the “8” button 28. When the Web button 22 is depressed these multi-buttons serve as arrow buttons, Up, Left, Right, Down respectively, to facilitate the navigation of user interface as depicted in Diagram 8a.

The numeric keypad 26 facilitates the selection of the desired links, as they are displayed on the screen in numeric form. The numeric keypad 26 can also be used to enter a desired TV channel when not in the Web mode.

The Enter button 27 is used in conjunction with the entry of a numeric link being entered, or number being entered to select a desired channel. The Enter button 27 has the purpose of accepting the entered data and completing the numeric selection process.

The menu button 30 will display a menu of options to provide the necessary setup processes for TV, VCR, DVD and/or other A/V devices. The menu button 30 also provides a menu to setup specific parameters necessary to access of the Internet, such as IP addresses, service provider telephone access number, etc, The Close button 31 deactivates the graphical digital overlay of Internet links, causing the displayed numbers to disappear, without being selected.

It has been contemplated that for better navigation of the Internet, that an IR capable alpha keypad (not shown) could alternatively be used in conjunction with the above described remote control unit 15.

General Overview of Diagrams and Functionality of the Invention

The following will define in detail the process of viewing, selecting and visiting Advertiser Web pages as defined in the present invention.

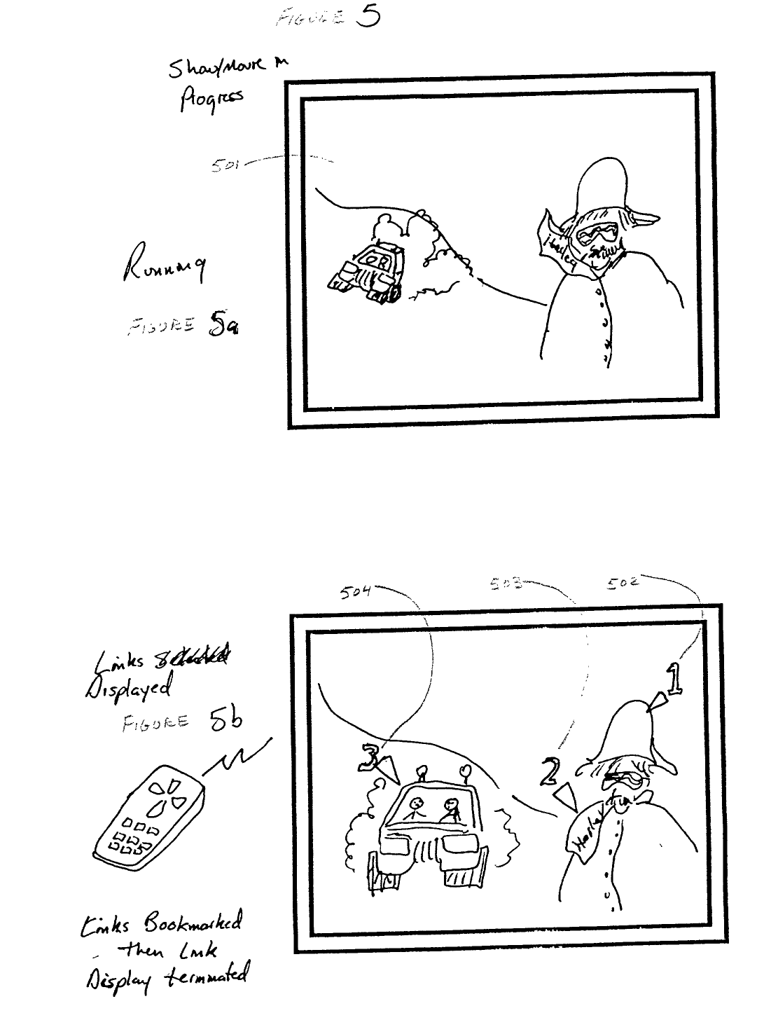

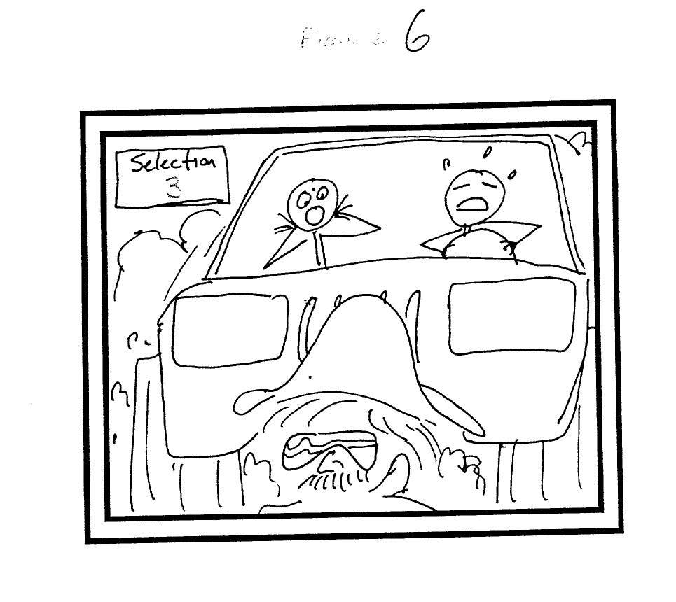

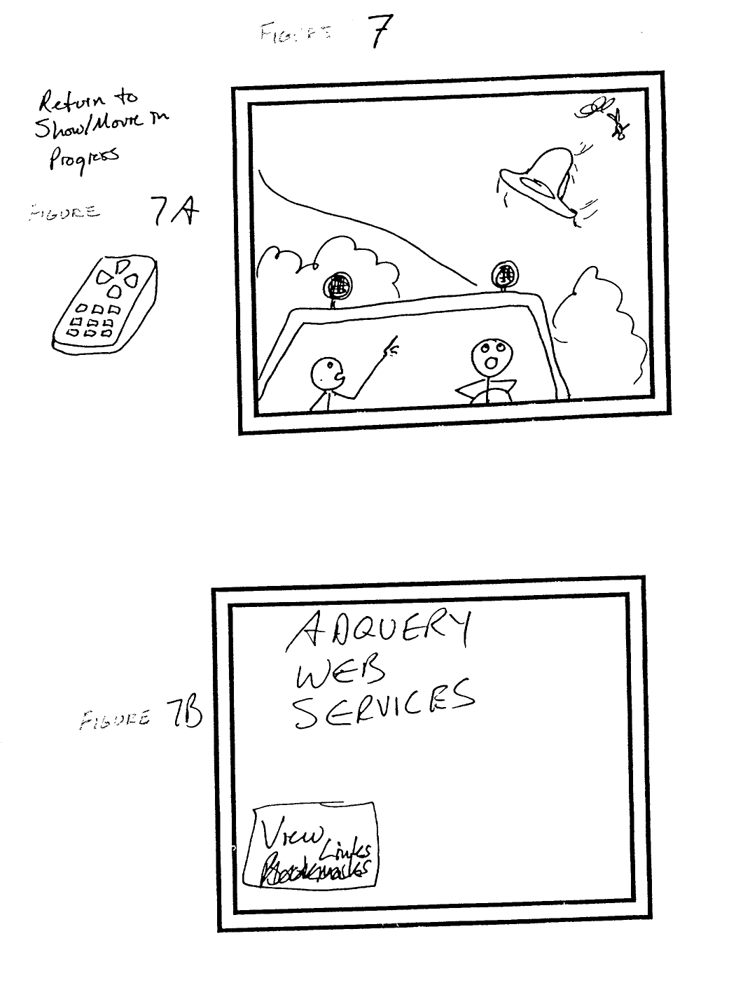

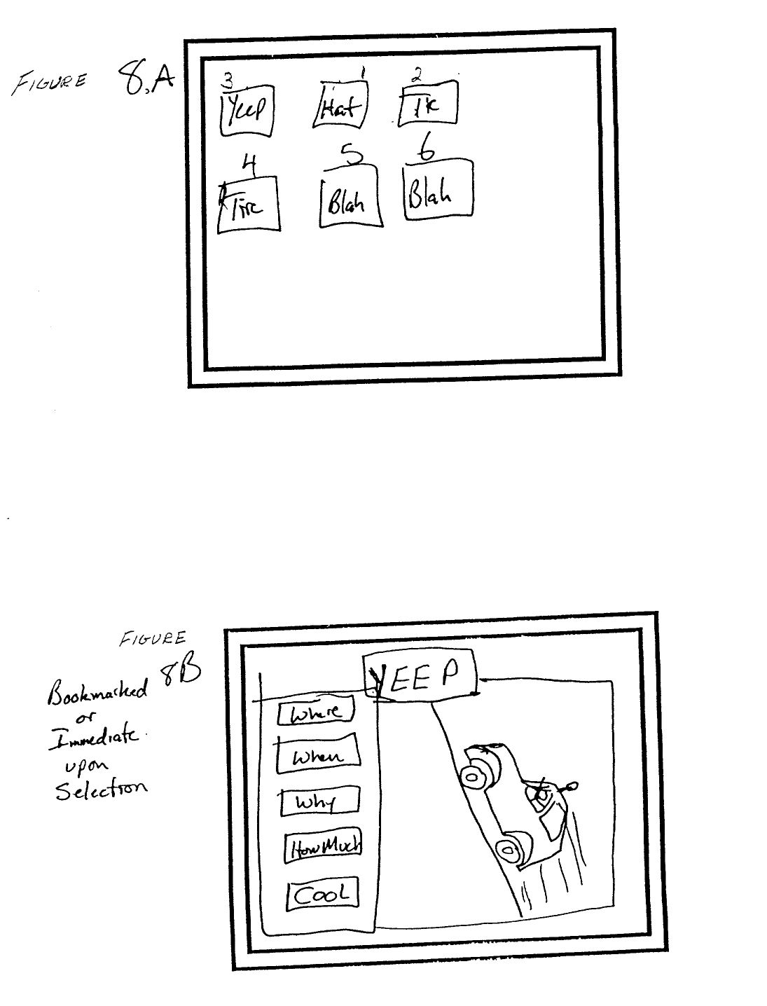

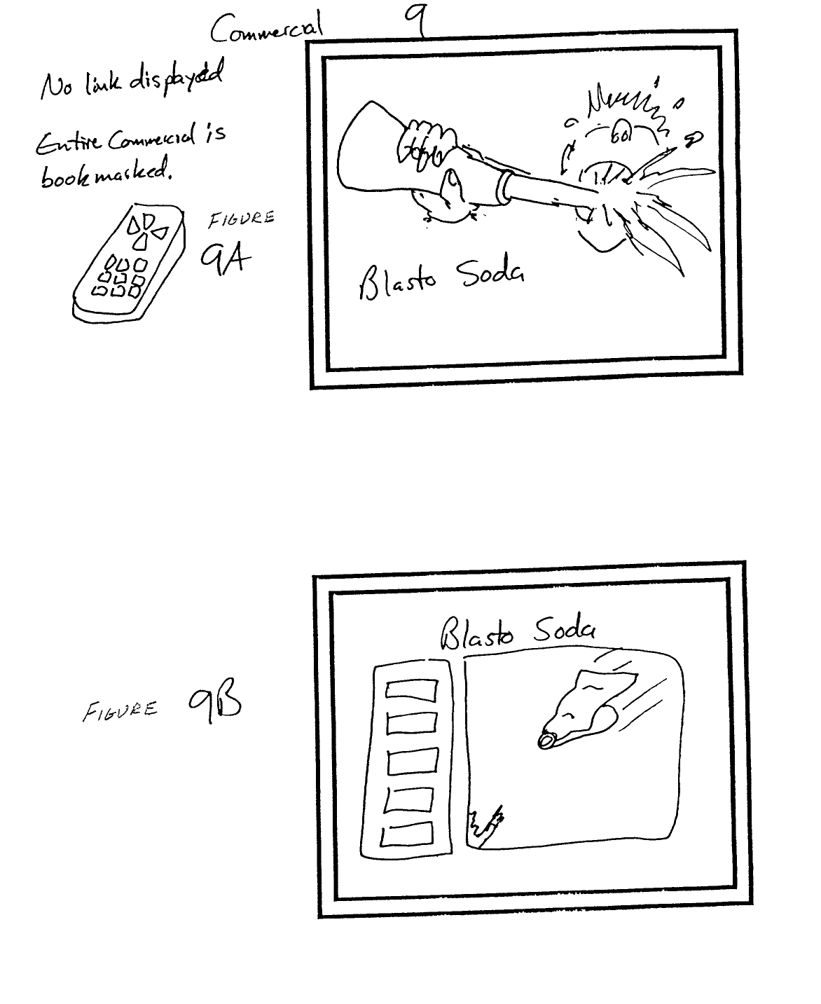

In reference to FIG. 5a, user is watching a program 501 provided through an A/V source, such as TV, DVD, VCR, Cable, Satellite, or other A/V device 1. The user is interested in viewing available Internet links on the program. The user depresses the Links button 23 on the Remote Control device 15. Upon pressing the Links button 23, all available Internet links are displayed as numeric digital overlays on the TV screen 502, 503, 504, as illustrated in FIG. 5b. The user selects the link associated with the Vehicle, by depressing the numeric “3” and then depressing the Enter button 27. As shown in FIG. 6, the selection is displayed as a verification of the selected link, while program continues without interruption. FIG. 7a illustrates that the links have disappeared, as a link selection was made. Links will not appear until the Links button 23 is depressed again. At anytime the user can depress the Web button 22, at which time the transceiver switches the viewing screen to the Internet, and also enables the multi-keys 24, 25, 28, 29 on the Remote Control unit 15. FIG. 7b illustrates the current contemplated best mode of the viewer interface as displayed by the transceiver as a digital overlay on the screen. By depressing any of the arrow keys (multi-keys 24, 25, 28, 29) until the View Links object is highlighted, the user can depress the Enter button 27 and go to another digital overlay, shown in FIG. 8a, that provides a list of previously selected links. These links are to be held in system memory 13 until they are deleted. Viewed links are grayed out but can still be accessed. Unviewed links are displayed normally (not grayed). By depressing the arrow keys (multi-keys 24, 25, 28, 29), the desired link is highlighted, selected by depressing the Enter button 27 and the transceiver accesses the Internet and views and accesses the desired link (web page) as illustrated in FIG. 8b. It is also contemplated, as illustrated in FIG. 9a, that as the user is watching a commercial and by depressing the Links button 23, the whole commercial Internet site is bookmarked. FIG. 9b illustrates a possible web page for the commercial. It is also contemplated that during a sportscast or sports event, the links that would show up after depressing the Links button 23 would connect the user to the sponsors' web pages. It is further contemplated that the sponsors may or may not be given commercial time during the sports event, but that some or all sponsors could have their Internet link (web page) displayed at anytime during the game together, when the Links button 23 is depressed.

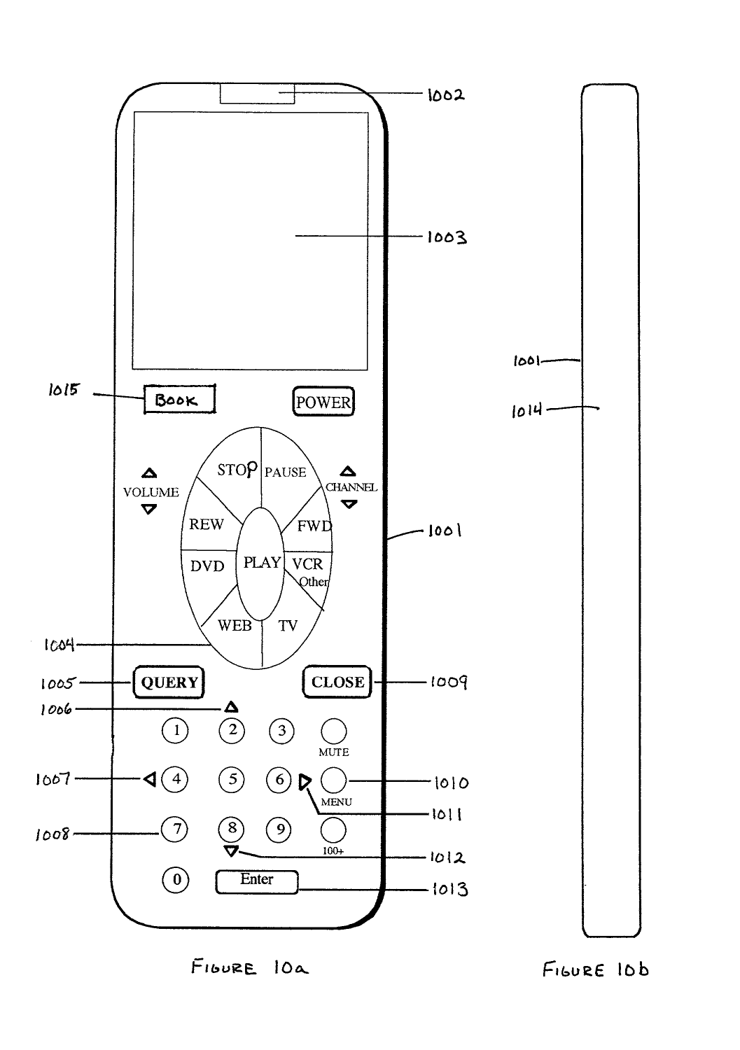

FIGS. 10a and 10b show the front and side views of the improved controller of this invention. This controller 1001 cooperates with improved circuitry and programming incorporated into the functions of FIG. 1 to provide additional functions and features of this invention. When used with this system this controller 1001 replaces and/or augments the previously described controller 15 in communication with the IR Control 14 of FIG. 1, via an IR window 1002. Like the previously described controller 15, this improved controller 1001 has a numeric keypad 1008, a set of switching buttons 1004, which in the present preferred embodiment include a Stop, Pause, FWD (forward), VCR, TV, Web, DVD and RWD (rewind) buttons each of which permits the user to activate and/or switch between the audio-visual devices. The keypad 1008 buttons typically have multiple uses, for example buttons 1006, 1007, 1011 and 1012 may be used as curser directional controls when the Web button has been pressed selecting Internet access. A Query button and function 1005 is provided to select and display the digital data channel information as a digital graphical overlay, both previously described and by activating a function in the CPU 12 which shows all available items for each individual scene on a selectable menu bar. The digital graphical overlay of numbers continues to be displayed on the television until the Close button/function 1009 is selected or until the user has selected a link. Link selection is typically accomplished by the user entering the corresponding number from the numeric keypad 1008 and depressing the Enter key 1013, at which point the signal is communicated to the IR Control 14, which converts the IR signal to an electrical signal constituting a link selection command. The CPU 12 upon receipt of the link selection command creates the URL for the selected scene content by locating and affixing the required URL (web site) information, i.e., http:// and www.adquery.com/ as well as html prefixes and suffixes as required. The CPU 12 interacts with an on-line database to retrieve the related information for each screen display, via the Internet service provider signal 1. By permitting the user to select an item on the television 3, have that selection communicated to the CPU 12 which accesses the on-line database to collect the required identification information, and which then creates the URL information, activating the internet connection 1 and downloading the Web site information associated with the particular selected item, this invention provides an easy remote-controllable means for a user to acquire information of interest from broadcast or pre-recorded television displayable programming. The improved main module 18 is capable of performing as a local Internet data server for one or more users, who typically enter their user identification on the keyboard 1008 for communication via the IR Control 104 to the CPU 12. This feature permits users to customize their particular scene content display or to surf the Internet independently based on their own particular interests. A display screen 1003, typically an LCD screen is provided on the controller 1001 to aid in the process of user customization feedback. For example, by viewing the display screen 1003 a user will be able to tell immediately whether the system is configured with their specific requirements or whether the user must enter his or her identification. A Book button/function 1015 is provided to give a quick interface to either bookmark a selected item or to review the previously saved bookmarks. FIG. 10b shows the side view 1014 of the controller 1001.

Conclusion

The present invention as described provides methods and apparatus for a unique audio interface for TV, VCR's, DVD's and other A/V devices integrated together with the internet. The present invention's functions and features provide a user interface which helps users find and view links of interest, access related information, control various audio devices and through the internet, order products, or services from their own homes. The present invention has been described with references to the various figures, naturally it should be understood that the figures are for illustration only, and do not limit the spirit and scope of the invention. For example, although the figures have, by necessity, used example screens having certain attributes, icons, criteria or functions, it will be appreciated that the invention is not limited by the specific examples provided. Rather, the present invention has application in any television and/or audio display system. In addition, it will be noted that the present invention may be realized using a variety of computer hardware and computer software, and is not limited to any particular hardware or software systems. Moreover, it will be appreciated that many of the functions and features of the present invention, such as graphic overlay panels, icons, and selection methods, are not static events and are perceived by the user as having motion, color, sound and/or animation.

As the described preferred embodiments of the invention should be considered in all respects only as illustrative of the current best mode of the invention and not as restrictive, the scope of the invention is indicated by the appended claims. Moreover, all systems, devices or methods which come within the meaning and range of the appended claims or which are equivalent to the appended claims are to be embraced within their scope.

1. An information retrieval system comprising:
(A) an audio-visual display for displaying received audio-visual signals to a user;
(B) a transceiver electrically coupled to said audio-visual display, said transceiver further comprising an interface generator for displaying internet links on said audio-visual display, a CPU which upon command creates a URL for access to the internet and an A/V connection which provides a connection to the internet for receiving internet information associated with said URL; and
(C) a controller in communication with said transceiver which permits the user to select and view selected audio-visual information from a signal source and to issue commands to said CPU of said transceiver.

2. An information retrieval system, as recited in claim 1, wherein said interface generator further provides a graphical digital overlay on said audio-visual display.

3. An information retrieval system, as recited in claim 1, wherein said controller further comprises an actuator for activating and interfacing with internet links displayed on said audio-visual display.

4. An information retrieval system, as recited in claim 1, wherein said interface generator further comprises a list generator for selectively displaying on said audio-visual display a list of information.

5. An information retrieval system, as recited in claim 4, wherein said list generator provides a picture-in-picture window.

6. An information retrieval system, as recited in claim 5, wherein said picture-in-picture window provides for continuous display of both Internet provided information and information received from a broadcast signal source.

7. An information retrieval system, as recited in claim 1, wherein said transceiver receives information from Internet.

8. An information retrieval system, as recited in claim 1, wherein said transceiver receives information from standard RF television signal reception.

9. An information retrieval system, as recited in claim 1, wherein said transceiver receives information from a broadcast system.

10. An information retrieval system, as recited in claim 1, wherein said transceiver receives information from a recorded media.

11. An information retrieval system, as recited in claim 6, wherein said picture-in-picture window provides information based on the user's selection using said controller.

12. An information retrieval system, as recited in claim 1, wherein said transceiver further comprises
(1) a central processing unit;
(2) digital memory electrically connected to said central processing unit;
(3) a remote control interface electrically connected to said central processor through a remote controller; and
(4) an audio-visual module, electrically connected to said central processing unit, to interface between said transceiver and an audio-visual signal source and said audio-visual display.

13. An information retrieval system as recited in claim 3, wherein said actuator further comprises:
(1) one or more buttons for user control of said transceiver; and
(2) a remote communication transmitter for providing a communication channel between said actuator and said transceiver.

14. An information retrieval system as recited in claim 1, wherein said interface generator provides listings of program and time information on said audio-visual display, upon command of said controller.

15. An information retrieval system as recited in claim 1, wherein said controller further comprises a recorder for storing user-selected information.

16. An information retrieval system as recited in claim 13, wherein said one or more buttons further comprises a mark button for use by the user in commanding said interface generator to display a reminder mark corresponding to a selected audio-visual program.

17. A method for generating and displaying audio-visual information received from the internet and at least one other audio-visual source, comprising the steps of:
(A) receiving an audio-visual signal;
(B) displaying said received audio-visual signal, wherein said audio-visual signal further comprises a selectable item;
(C) selecting said selectable item from said displayed audio-visual signal;
(D) generating an Internet address associated with said selected item;
(E) receiving information from the internet for said internet address of said displayed item from said audio-visual signal; and
(F) displaying said selected information on an audio-visual display.

18. A method for generating and displaying audio-visual information, as recited in claim 17, wherein said selecting step further comprises:
(1) providing a list of information related to said received audio-visual signal;
(2) activating said provided list for display upon user command;
(3) identifying an item from said activated list;
(4) displaying said identified item on an audio-visual display;
(5) communicating the selection of said item to a computer device for said generation of an associated Internet address.

19. A method for generating and displaying audio-visual information, as recited in claim 17, wherein said displaying step further comprises:
(1) opening a display window on the audio-visual display device;
(2) inserting selected information in said opened display window; and
(3) continuing the display of audio-visual information from an audio-visual information source.

20. A method for generating and displaying audio-visual information, as recited in claim 17, wherein said selecting information step further comprises selecting programming information.

21. A method for generating and displaying audio-visual information, as recited in claim 17, wherein said selecting information step further comprises selecting product information.

22. A method for generating and displaying audio-visual information, as recited in claim 17, wherein said selecting information step further comprises selecting service information.

23. A method for generating and displaying audio-visual information, as recited in claim 17, wherein said selecting information step further comprises selecting public service information.

24. A method for generating and displaying audio-visual information, as recited in claim 17, further comprising inquiring of a user for user information.
